(19) United States
(12) Patent Application Publication
(10) Pub. No.: US 2016/0353216 A1
(43) Pub. Date: Dec. 1, 2016

(54) SELF-ALIGNING COMFORT FIT RETENTION ARM FOR A HEARING ASSISTANCE DEVICE

(71) Applicants: Jerome C. Ruzicka, Plymouth, MN (US); Keith Guggenberger, Minnetonka, MN (US); Brian Michael Harden, Brooklyn Park, MN (US)

(72) Inventors: Jerome C. Ruzicka, Plymouth, MN (US); Keith Guggenberger, Minnetonka, MN (US); Brian Michael Harden, Brooklyn Park, MN (US)

(21) Appl. No.: 14/722,891

(22) Filed: May 27, 2015

(51) Int. Cl. H04R 25/00

(52) U.S. Cl. CPC H04R 25/652; H04R 2225/021; H04R 2225/023; H04R 2225/025

(57) ABSTRACT

Disclosed herein, among other things, are systems and methods for in-the-ear retention for hearing assistance devices. One aspect of the present subject matter includes a hearing assistance device configured to compensate for hearing losses of a user. The hearing assistance device includes an in-the-ear portion configured to be worn in an ear of a wearer, and an adjustable detachable rigid arm configured to connect to the in-the-ear portion. According to various embodiments, the arm is configured to provide a retention fit for the in-the-ear portion using bends in an ear canal of the ear.

### TECHNICAL FIELD

This document relates generally to hearing assistance systems and more particularly to methods and apparatus for a self-aligning comfort fit retention arm for a hearing assistance device.

### BACKGROUND

Modern hearing assistance devices, such as hearing aids, are electronic instruments worn in or around the ear that compensate for hearing losses of hearing-impaired people by specially amplifying sound. Hearing aids typically include a housing or shell with internal components such as a signal processor, a microphone and a receiver housed in a receiver case. The housing or shell of a hearing assistance device has a size limitation based on the application. Specifically, devices that include an in-the-ear portion have housings that are constrained by the geometry of the inner ear of the wearer. In addition, it is difficult to attain universal comfort and retention for in-the-ear hearing aids that reside in the concha.

Accordingly, there is a need in the art for improved systems and methods for retaining an in-the-ear portion of a hearing assistance device.

### SUMMARY

Disclosed herein, among other things, are systems and methods for in-the-ear retention for hearing assistance devices. One aspect of the present subject matter includes a hearing assistance device configured to compensate for hearing losses of a user. The hearing assistance device includes an in-the-ear portion configured to be worn in an ear of a wearer, and an adjustable detachable rigid arm configured to connect to the in-the-ear portion. According to various embodiments, the arm is configured to provide a retention fit for the in-the-ear portion using bends in an ear canal of the ear.

One aspect of the present subject matter includes a hearing assistance device method. The method includes providing a hearing assistance device including a portion configured to be worn in an ear of a wearer. According to various embodiments, the method further includes providing an adjustable detachable rigid arm configured to connect to the in-the-ear portion, the arm configured to provide a retention fit for the in-the-ear portion using bends in an ear canal of the ear.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 illustrates a portion of a hearing assistance device including a self-aligning comfort fit retention arm, according to various embodiments of the present subject matter.

FIGS. 2A-2D illustrate various orientations for hearing assistance devices including a self-aligning comfort fit retention arm, according to various embodiments of the present subject matter.

FIG. 3 illustrates an ear canal geometry for placement of a hearing assistance device.

FIG. 4 illustrates a side view of a hearing assistance device including a self-aligning comfort fit retention arm, according to various embodiments of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present detailed description will discuss hearing assistance devices using the example of hearing aids. Hearing aids are only one type of hearing assistance device. Other hearing assistance devices include, but are not limited to, those in this document. It is understood that their use in the description is intended to demonstrate the present subject matter, but not in a limited or exclusive or exhaustive sense.

Hearing aids typically include a housing or shell with internal components such as a signal processor, a microphone and a receiver housed in a receiver case. The housing or shell of a hearing assistance device has a size limitation based on the application. Specifically, devices that include an in-the-ear portion have housings that are constrained by the geometry of the inner ear of the wearer. In addition, it is difficult to attain universal comfort and retention for in-the-ear hearing aids that reside in the concha. Previous attempts to solve this problem include articulating arms that are non-replaceable due to containing receivers or being constructed of a flexible tube requiring bonding to the body of the device. In addition, units with a rigid arm and bud fail to protect the canal from the rigid polymer or provide a means of wax protection. Thus, insertion depth and comfort suffer due to the nature of the bud/arm interface.

Disclosed herein, among other things, are systems and methods for in-the-ear retention for hearing assistance devices. One aspect of the present subject matter includes a hearing assistance device configured to compensate for hearing losses of a user. The hearing assistance device includes an in-the-ear portion configured to be worn in an ear of a wearer, and an adjustable detachable rigid arm configured to connect to the in-the-ear portion. According to various embodiments, the arm is configured to provide a retention fit for the in-the-ear portion using bends in an ear canal of the ear. One aspect of the present subject matter includes a hearing assistance device method. The method includes providing a hearing assistance device including a portion configured to be worn in an ear of a wearer. According to various embodiments, the method further includes providing an adjustable detachable rigid arm configured to connect to the in-the-ear portion, the arm configured to provide a retention fit for the in-the-ear portion using bends in an ear canal of the ear. Thus, the present subject matter provides a retention arm/bud combination that anchors the device while maintaining comfort. In various embodiments, the in-the-ear portion includes a comfort earbud, such as disclosed in the commonly assigned U.S. patent application “Enhanced Comfort Earbud,” Ser. No. 14/437,392, filed on Aug. 25, 2014, which is hereby incorporated by reference herein in its entirety.

When designing an instant fit hearing device which resides in the concha, comfort and retention are usually difficult to attain universally. The present subject matter provides a mechanism that not only adapts to the transitional angle from the concha to the external acoustic meatus (portion), but also provides for retention at and around the first bend in the canal. In addition, the present subject matter provides a series of replacement arms for varying anatomies, angle and depth. According to various embodiments, the apparatus of the present subject matter provides a single solution for left and right ears. The present subject matter further provides a conformal element to hold snugly yet comfortably to the typical bends in the ear canal.

The present subject matter adds adaptability, comfort, and retention in one simple mechanism. By adapting the articulating arm to accept a comfortable ear bud, the two work together to produce a type of ‘ear canal lock’. In various embodiments, an arm portion can be used such as disclosed in the commonly assigned U.S. patent application “Modular Connection Assembly for a Hearing Assistance Device,” Ser. No. 12/548,051, filed on Aug. 26, 2009 (which is continued by U.S. Ser. No. 14/301,103 filed on Jun. 10, 2014), and in commonly assigned U.S. Pat. No. 8,385,573 filed Sep. 19, 2007 (which is continued by U.S. Ser. No. 14/512,560 filed on Oct. 13, 2014), all of which are hereby incorporated by reference herein in their entirety. The present subject matter provides a self-aligning rigid component with a conformal bud placed to aid in retention internal to the ear canal. In addition, the present subject matter provides for comfortable placement in the concha while presenting the bud to the first bend. Once there the bud conforms, using the bend as an anchor point, retaining the device with uniform pressure exerted on the canal walls in various embodiments.

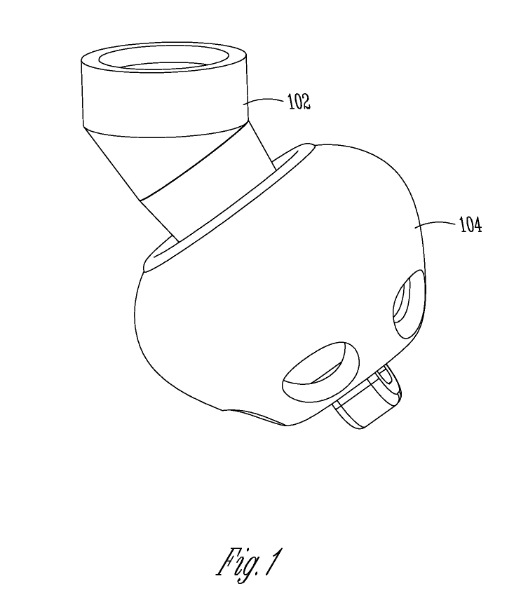

FIG. 1 illustrates a portion of a hearing assistance device including a self-aligning comfort fit retention arm, according to various embodiments of the present subject matter. The device includes an articulating rigid arm 102 available in multiple lengths and angles, in various embodiments. According to various embodiments, the device includes a conformal ear bud 104. The bud 104 includes wax protection in various embodiments.

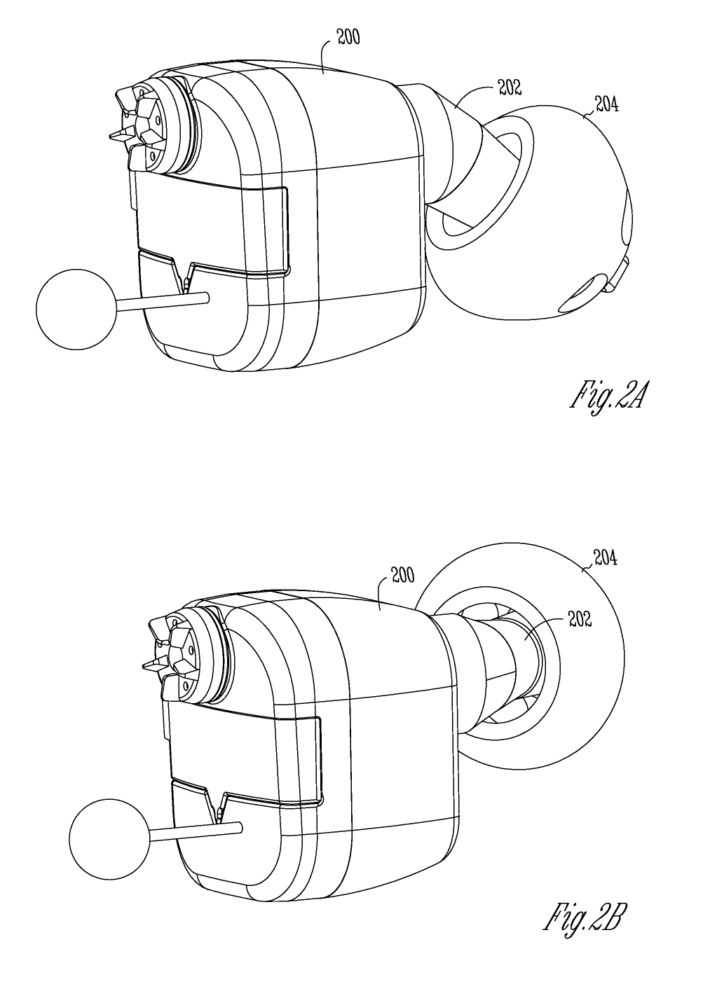

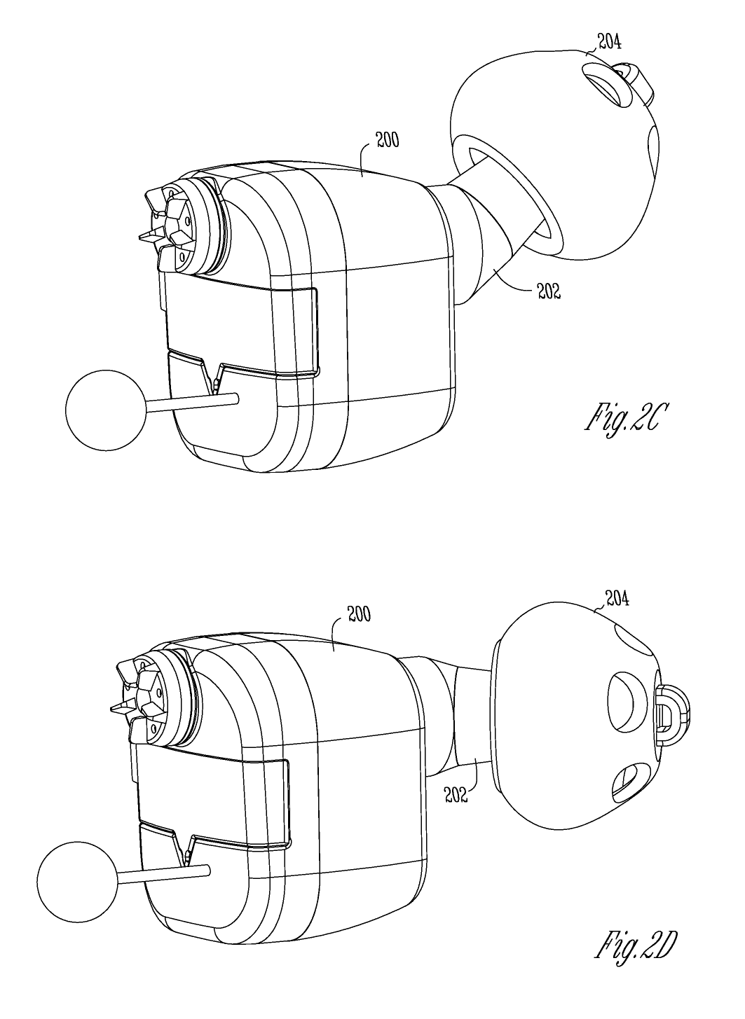

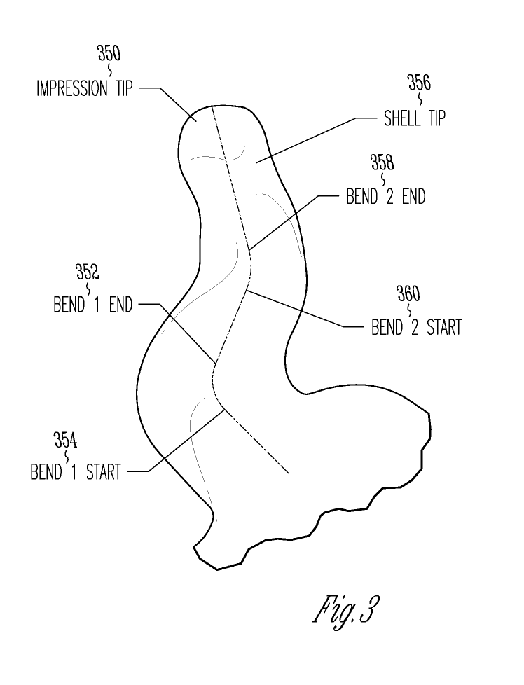

FIGS. 2A-2D illustrate various orientations for hearing assistance devices including a self-aligning comfort fit retention arm, according to various embodiments of the present subject matter. The housing 200 is removably attached to a retention arm 202, in an embodiment. The retention arm 202 is removably attached to an ear bud 204, in various embodiments. FIGS. 2A-2D show the arm 202 attached with 360 degree rotational possibilities, in various embodiments. Depth adjustment, not shown, is achieved by varying the length and/or the angle with a similar replacement arm, in various embodiments.

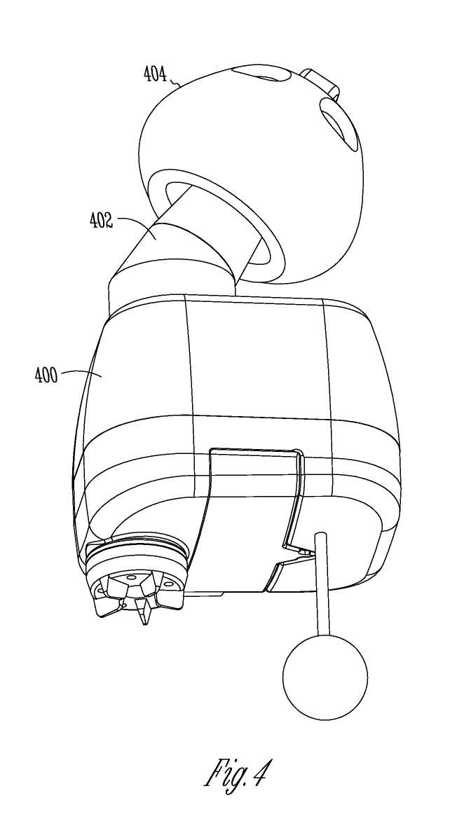

FIG. 3 illustrates an ear canal geometry for placement of a hearing assistance device. The depicted placement geometry includes an impression tip 350, bend 1 start 354, bend 1 end 352, shell tip 356, bend 2 end 358 and bend 2 start 360. FIG. 4 illustrates a side view of a hearing assistance device including a self-aligning comfort fit retention arm 402, and ear bud 404, and a housing 400, according to various embodiments of the present subject matter. In various embodiments, the arm/bud assembly is sized to place the comfort bud in a position to wrap around or past the area from bend 1 start 354 to bend 1 end 352. The rigid arm 402, once roughly aligned, will self-center leaving minimal to no contact with the canal walls in various embodiments. In various embodiments, barbs are completely encased inside the bud 404 so that no rigid polymer protrudes from the tip. Additional embodiments include the use of ear molds, curved thin tubes and RIC receiver housings.

In various embodiments, the present subject matter provides a replaceable retention arm that provides self alignment, or a sort of sport lock for a hearing aid. In various embodiments, length of the arm is articulating and adjustable, and parts can be swapped out for length or rotational adjustment. The present subject matter adds adaptability, comfort and retention in one mechanism that adapts an articulating arm and ear bud to produce an ear canal lick in both open and occluded fittings, in various embodiments.

Hearing assistance devices typically include at least one enclosure or housing, a microphone, hearing assistance device electronics including processing electronics, and a speaker or “receiver.” Hearing assistance devices may include a power source, such as a battery. In various embodiments, the battery may be rechargeable. In various embodiments multiple energy sources may be employed. It is understood that in various embodiments the microphone is optional. It is understood that in various embodiments the receiver is optional. It is understood that variations in communications protocols, antenna configurations, and combinations of components may be employed without departing from the scope of the present subject matter. Antenna configurations may vary and may be included within an enclosure for the electronics or be external to an enclosure for the electronics. Thus, the examples set forth herein are intended to be demonstrative and not a limiting or exhaustive depiction of variations.

It is understood that digital hearing aids include a processor. In digital hearing aids with a processor, programmable gains may be employed to adjust the hearing aid output to a wearer's particular hearing impairment. The processor may be a digital signal processor (DSP), microprocessor, microcontroller, other digital logic, or combinations thereof. The processing may be done by a single processor, or may be distributed over different devices. The processing of signals referenced in this application can be performed using the processor or over different devices. Processing may be done in the digital domain, the analog domain, or combinations thereof. Processing may be done using subband processing techniques. Processing may be done using frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, buffering, and certain types of filtering and processing. In various embodiments the processor is adapted to perform instructions stored in one or more memories, which may or may not be explicitly shown. Various types of memory may be used, including volatile and nonvolatile forms of memory. In various embodiments, the processor or other processing devices execute instructions to perform a number of signal processing tasks. Such embodiments may include analog components in communication with the processor to perform signal processing tasks, such as sound reception by a microphone, or playing of sound using a receiver (i.e., in applications where such transducers are used). In various embodiments, different realizations of the block diagrams, circuits, and processes set forth herein can be created by one of skill in the art without departing from the scope of the present subject matter.

In various embodiments, the present subject matter is used in hearing assistance devices that are configured to communicate with mobile phones. In such embodiments, the hearing assistance device may be operable to perform one or more of the following: answer incoming calls, hang up on calls, and/or provide two way telephone communications. In various embodiments, the present subject matter is used in hearing assistance devices configured to communicate with packet-based devices. In various embodiments, the present subject matter includes hearing assistance devices configured to communicate with streaming audio devices. In various embodiments, the present subject matter includes hearing assistance devices configured to communicate with Wi-Fi devices. In various embodiments, the present subject matter includes hearing assistance devices capable of being controlled by remote control devices.

It is further understood that different hearing assistance devices may embody the present subject matter without departing from the scope of the present disclosure. The devices depicted in the figures are intended to demonstrate the subject matter, but not necessarily in a limited, exhaustive, or exclusive sense. It is also understood that the present subject matter can be used with a device designed for use in the right ear or the left ear or both ears of the wearer.

The present subject matter may be employed in hearing assistance devices, such as headsets, headphones, and similar hearing devices.

The present subject matter is demonstrated for hearing assistance devices, including hearing aids, including but not limited to, behind-the-ear (BTE), in-the-ear (ITE), in-the-canal (ITC), receiver-in-canal (RIC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and such as deep insertion devices having a transducer, such as a receiver or microphone, whether custom fitted, standard fitted, open fitted and/or occlusive fitted. It is understood that other hearing assistance devices not expressly stated herein may be used in conjunction with the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

1. A hearing assistance device, comprising:
a conformal in-the-ear portion configured to be worn in an ear of a wearer; and
an adjustable detachable rigid arm configured to connect to the in-the-ear portion, a portion of the arm and the conformal in-the-ear portion configured to provide a retention fit for the in-the-ear portion using bends in an ear canal of the ear, and wherein in-the-ear portion is configured to be used with a plurality of adjustable detachable rigid arms such that the device is configured to be used in both left and right ears of the wearer.

2. The hearing assistance device of claim 1, wherein the adjustable detachable rigid arm is configured to adapt to a transitional angle from a concha to an external acoustic portion and provide for retention at a first bend in the ear canal.

3. The hearing assistance device of claim 1, further comprising a plurality of replacement arms for varying wearer ear canal angles.

4. The hearing assistance device of claim 1, wherein the hearing assistance device includes a hearing aid.

5. The hearing assistance device of claim 4, wherein the hearing aid includes an in-the-ear (ITE) hearing aid.

6. The hearing assistance device of claim 1, further comprising a plurality of replacement arms for varying wearer ear canal depths.

7. The hearing assistance device of claim 4, wherein the hearing aid includes an in-the-canal (ITC) hearing aid.

8. The hearing assistance device of claim 4, wherein the hearing aid includes a receiver-in-canal (MC) hearing aid.

9. The hearing assistance device of claim 1, wherein the arm is configured to rotate 360 degrees with respect to the in-the-ear portion.

10. The hearing assistance device of claim 1, wherein the adjustable detachable rigid arm is configured to self-align in the ear canal.

11. A method, comprising:
providing a hearing assistance device including a conformal portion configured to be worn in an ear of a wearer; and
providing an adjustable detachable rigid arm configured to connect to the in-the-ear portion, a portion of the arm configured to provide a retention fit for the in-the-ear portion using bends in an ear canal of the ear, and wherein in-the-ear portion is configured to be used with a plurality of adjustable detachable rigid arms such that the device is configured to be used in both left and right ears of the wearer.

12. The method of claim 11, wherein the adjustable detachable rigid arm is configured to adapt to a transitional angle from a concha to an external acoustic portion and provide for retention at a first bend in the ear canal.

13. The method of claim 11, wherein the adjustable detachable rigid arm is configured to self-align in the ear canal.

14. The method of claim 11, wherein the hearing assistance device includes a hearing aid.

15. The method of claim 14, wherein the hearing aid includes an in-the-ear (ITE) hearing aid.

16. The method of claim 13, wherein the adjustable detachable rigid arm is configured to self-center in the ear canal to minimize contact with ear canal walls.

17. The method of claim 14, wherein the hearing aid includes an in-the-canal (ITC) hearing aid.

18. The method of claim 14, wherein the hearing aid includes a receiver-in-canal (RIC) hearing aid.

19. The method of claim 11, wherein the in-the-ear portion is configured to conform to the ear canal and use a first bend in the ear canal as an anchor point.

20. The method of claim 11, wherein the in-the-ear portion is configured to provide wax protection.
